(19) United States
(12) Patent Application Publication
(10) Pub. No.: US 2026/0034980 A1
(43) Pub. Date: Feb. 5, 2026

(54) METHOD FOR OPERATING A DRIVER ASSISTANCE SYSTEM OF A COMMERCIAL VEHICLE

(71) Applicant: DAIMLER TRUCK AG, Leinfelden-Echterdingen (DE)

(72) Inventors: Stefan ZÄNKER, Laupheim (DE); Hartmut RAISER, Altbach (DE); Maximilian TONK, Gelsenkirchen (DE); Istvan VEGH, Karlsruhe (DE)

(21) Appl. No.: 18/998,255

(22) PCT Filed: May 9, 2023
(86) PCT No.: PCT/EP2023/062309

§ 371 Date: Jan. 24, 2025

(30) Foreign Application Priority Data
Jul. 27, 2022 (DE) 10 2022 118 852.3

(51) Int. Cl. B60W 30/09; B60T 7/22; B60T 8/17; B60T 8/1755; B60W 50/16

(52) U.S. Cl. CPC B60W 30/09; B60T 7/22; B60T 8/1708; B60T 8/17558; B60W 50/16; B60W 2300/14

(57) ABSTRACT

A method for operating a driver assistance system of a commercial vehicle having two vehicle wheels pivotably arranged on a front axle is provided. An environment of the commercial vehicle is detected by a detection device of the driver assistance system. When there is an imminent collision with an object, which is formed separately from the commercial vehicle and located in the environment, is detected by the detection device during a stop approach, a parking maneuver, or a turning maneuvers of the commercial vehicle, one of the vehicle wheels is braked by a braking intervention effected by a braking device of the commercial vehicle so that the vehicle wheels are pivoted as a result of the braking intervention in order to prevent the collision of the commercial vehicle with the object.

### BACKGROUND AND SUMMARY OF THE INVENTION

Exemplary embodiments of the invention relate to a method for operating a driver assistance system of a commercial vehicle having two vehicle wheels pivotably arranged on a front axle.

DE 10 2016 006 466 A1 discloses a method for changing a steering angle of a motor vehicle, wherein two steered wheels are coupled to an axle of the motor vehicle via a steering mechanism for presetting the wheel angles of the steered wheels about a vertical axis of the motor vehicle depending on the steering angle, and wherein at least one braking intervention is carried out by a braking device of the motor vehicle, by means of which one braked of the steered wheels is braked more strongly than another of the steered wheels.

In addition, a turning control system for a vehicle with four wheels and a steering wheel which controls the steering of two of the wheels is known from U.S. Pat. No. 7,318,629 B1.

Exemplary embodiments of the present invention are directed to a method for operating a driver assistance system of a commercial vehicle having two wheels pivotably arranged on a front axle, such that the safety of the commercial vehicle can be particularly increased with particularly little effort.

The invention relates to a method for operating a driver assistance system of a commercial vehicle having at least two vehicle wheels arranged pivotably on a front axle, in particular about a respective pivot axle. The commercial vehicle is designed, for example, as a bus, in particular as an omnibus or a passenger bus. Alternatively, the commercial vehicle is formed, for example, as a lorry, in particular as a tractor unit. By way of example, the commercial vehicle is an articulated lorry. In particular, the articulated lorry can be understood as a combination of the tractor unit and a semi-trailer, in particular referred to as a trailer.

In its completely manufactured state, the commercial vehicle has the front axle. Preferably, the commercial vehicle has at least one rear axle formed separately from the front axle. The front axle is arranged in front of the rear axle in the longitudinal direction of the commercial vehicle. The vehicle wheels are rotatable about a respective wheel rotation axis, in particular relative to a chassis of the commercial vehicle. The respective wheel can be understood, in particular, as a respective ground contact element of the commercial vehicle. Preferably, the vehicle wheels are supported on the chassis of the commercial vehicle via the front axle, in particular in the vertical direction of the commercial vehicle. Preferably, the vehicle wheels are spaced apart from each other in the transverse direction of the commercial vehicle. By way of example, a first of the vehicle wheels is designed as the left vehicle wheel of the commercial vehicle and the second of the wheels is designed, for example, as the right vehicle wheel of the commercial vehicle.

The vehicle wheels are arranged on the front axle so as to be pivotable about the respective pivot axis, in particular relative to the chassis of the commercial vehicle, in particular to effect cornering or changes of direction of the commercial vehicle. By pivoting the respective vehicle wheel, a respective steering angle can be effected, in particular to effect cornering or changes in direction of the commercial vehicle. The respective steering angle can be understood, in particular, as a respective deflection or a respective steering angle of the respective vehicle wheel in relation to the longitudinal direction of the commercial vehicle. The pivot axis preferably runs at least substantially at an angle or perpendicular to the respective wheel pivot axis. By way of example, the pivot axis runs at least substantially in the vertical direction of the vehicle. By way of example, the pivot axis runs at an angle or perpendicular to the transverse direction of the vehicle and/or to the longitudinal direction of the commercial vehicle, wherein the pivot axis can be inclined by a castor angle and/or by a spread angle of the respective vehicle wheel. By way of example, the respective wheel pivot axis runs at least substantially in the transverse direction of the vehicle.

In the method, an environment of the commercial vehicle is detected by means of a detection device of the driver assistance system, in particular of the commercial vehicle. In other words, the detection device is used to determine and/or monitor the environment of the commercial vehicle.

The environment of the commercial vehicle comprises, for example, at least one road. The road can, for example, comprise at least one lane. In particular, the lane can be understood as part of the road, for example indicated or delimited by corresponding markings, on which the commercial vehicle travels in one direction.

By way of example, a speed, in particular a current speed, of the commercial vehicle is detected, in particular by means of a second detection device of the commercial vehicle, which is designed separately from the detection device. In other words, the speed, in particular the current speed, of the commercial vehicle is determined and monitored, in particular by means of the second detection device.

The detection device is designed to detect an imminent collision with at least one object that is separate from the commercial vehicle and located in its environment. This means that the detection of the imminent collision with the object can be effected at least partially, in particular completely, by the detection device. By way of example, at least one variable characterizing the object can be detected by means of the detection device. The detection device can thus be used to detect the at least one variable characterizing the object. By way of example, the variable characterizing the object detected by the detection device is transmitted to an electronic computing device of the driver assistance system, in particular of the commercial vehicle, which is designed separately from the detection device. By way of example, the imminent collision with the object is determined, in particular calculated, by means of the electronic computing device depending on the transmitted variable. This means, for example, that it is determined, in particular predicted, in particular by means of the electronic computing device, whether the collision with the object is imminent, i.e., will most probably occur, or whether the collision with the object will not occur.

To increase the safety of the commercial vehicle in a particularly low-effort manner, it is provided that when the imminent collision with the at least one object which is separate from the commercial vehicle and is located in the environment is detected, in particular when it is determined, by means of the detection device, in particular by means of the electronic computing device, during a stop approach, a parking maneuver or a turning maneuver of the commercial vehicle, one of the vehicle wheels is braked, in particular in a targeted manner, by a braking intervention effected by a braking device of the commercial vehicle. This means that during the stop approach or the parking maneuver or the turning maneuver, i.e., while the commercial vehicle is in the stop approach, the parking maneuver or the turning maneuver, one of the vehicle wheels is braked, in particular in a targeted manner, by the braking intervention effected by the braking device if the imminent collision with the object is detected, in particular determined, by means of the detection device, in particular the electronic computing device. In other words, when the stop approach, the parking maneuver or the turning maneuver is recognized by means of the detection device, and in particular by means of the electronic computing device, and when the imminent collision with the object is detected by means of the detection device, and in particular by means of the electronic computing device, one of the vehicle wheels is braked by the braking intervention effected by the braking device of the commercial vehicle. As a result of the braking of the vehicle wheel by the braking intervention effected by the braking device, the vehicle wheels are pivoted as a result of the braking intervention, in particular about the pivot axis, in order to prevent the collision of the commercial vehicle with the object. In other words, one of the vehicle wheels is braked by the braking intervention effected by the braking device of the commercial vehicle, in particular in a targeted manner, in such a way that the vehicle wheels are pivoted as a result of the braking action, in particular about the respective pivot axis, in order to prevent the collision of the commercial vehicle with the object. This means that the braking of the vehicle wheel can cause the vehicle wheels to pivot, in particular about the respective pivot axis of both vehicle wheels, whereby the collision of the commercial vehicle with the object can be avoided or prevented. In other words, when the stop approach, the parking maneuver or the turning maneuver is detected and the imminent collision with the object is detected, the steering angle on one of the vehicle wheels on the front axle of the commercial vehicle is adjusted by the braking intervention in order to prevent the collision of the commercial vehicle with the object.

This means, in particular, that the braking intervention on one of the vehicle wheels on the front axle can cause a torque, known in particular as steering torque, to pivot the vehicle wheels about the respective pivot axis, thereby changing the respective current steering angle. As a result, the current direction of travel of the commercial vehicle can be influenced or changed. This means that a change in direction of the commercial vehicle can be effected. This means that a collision with the object can be prevented using the method by adjusting the steering angle by means of a single wheel brake intervention or by means of several single wheel brake interventions on the front axle of the commercial vehicle during the stop approach, the parking maneuver or the turning maneuver. In other words, the vehicle wheels, in particular referred to as front wheels, can be made to turn by applying the brakes to one side of the front axle. Preventing the collision of the commercial vehicle with the object can be understood in particular to mean that the collision of the commercial vehicle with the object can be prevented by changing or influencing the direction of travel of the commercial vehicle and/or by changing the direction of the commercial vehicle. As a result of the braking intervention, the object can thus, for example, be driven around or bypassed by the commercial vehicle. In particular, the braking device can be referred to as a braking system.

The object is, for example, an item, in particular another vehicle separate from the commercial vehicle or a curb. Alternatively, the object is, for example, a person.

The stop approach can be understood in particular as a driving maneuver, in particular a stopping maneuver, of the commercial vehicle, wherein the commercial vehicle drives to the stop during the stop approach and in particular stops at the stop, i.e., decelerates until the commercial vehicle comes to a standstill. In particular, the stop can be understood as a defined destination point or stopping point on a predetermined route of the commercial vehicle. In particular, if the commercial vehicle is designed as a passenger bus or omnibus, for example, the stop can be a bus stop, for example.

The parking maneuver can be understood, in particular, as a parking process of the commercial vehicle. In particular, the parking process can be referred to as a parking-up process. This means, in particular, that the commercial vehicle is parked or parked up at a defined destination during the parking maneuver, for example.

The turning maneuver can be understood in particular as a turning of the commercial vehicle. In particular, turning can be understood to mean a change in the direction of travel of the commercial vehicle, for example to the left or to the right, at crossroads and/or at a junction. The crossroads or junction can be understood in particular as an intersection on the roadway, in particular the lane.

By way of example, it is provided that when the imminent collision with the object is detected during the stop approach, the parking maneuver or the turning maneuver, one of the vehicle wheels is braked, in particular in a targeted manner, by the braking intervention effected by a braking device of the commercial vehicle in such a way that the vehicle wheels are pivoted as a result of the braking intervention, in particular about the respective pivot axis, in order to perform at least one lane-correcting function. During the lane-correcting function, the commercial vehicle is held in its lane or returned to its original lane, for example.

The invention is based in particular on the following findings and considerations: in a conventional method or a conventional steering system, in particular with hydraulic assistance, no steering angle can be set for, in particular active, driver assistance systems. By way of example, in a conventional method or in a conventional steering system, a steering gear can be provided with an electric motor, in particular an additional electric motor, which enables active adjustment of the steering. However, the electric motor is usually an additional component, which can have negative effects on the costs, weight, installation space, and maintenance of the commercial vehicle. Alternatively, in a conventional method, for example, a yaw moment can be generated, in particular without adjusting the steering angle, by a one-sided brake intervention, in particular in a non-steered axle of the commercial vehicle. However, in the case of the commercial vehicle, especially in the case of a particularly long or heavy commercial vehicle, this can only lead to a particularly small change in direction of the commercial vehicle caused by the yaw moment.

In contrast, in the method according to the invention, direct adjustment of the steering can be effected by the braking intervention, in particular by the individual wheel braking device, i.e., the steering angle can be adjusted directly. In particular, a sufficiently large or particularly large kingpin offset of the steering axle can be used to set the steering angle with the aid of the braking intervention on the respective pivot axle, which is referred to in particular as the steering axle. The kingpin offset can act as a lever arm, which, in combination with a braking force on the vehicle wheel, in particular on the one side, can cause the steering torque on the steering axle. As a result, the safety of the commercial vehicle can be increased in a particularly low-effort manner, in particular without the installation of additional components. The safety of the commercial vehicle, which can be particularly difficult to assess and/or particularly confusing due to its size, for example, can be particularly increased by active safety functions, in particular when approaching a stop and/or during the parking maneuver and/or during the turning maneuver. Furthermore, the method according to the invention can particularly increase the comfort of the commercial vehicle, in particular compared to a commercial vehicle without driver assistance systems or with particularly limited driver assistance systems, in particular for the driver of the commercial vehicle.

When approaching a stop, tire damage caused by curb contact, for example, can be prevented, particularly on the side of the commercial vehicle facing the stop. This can particularly increase the service life of a respective tire of the respective vehicle wheel. Furthermore, when approaching the stop, a gap between the curb and the commercial vehicle, which is formed as a bus, for example, can be kept particularly small in order to allow a person to enter the commercial vehicle particularly easily and, in particular, safely. At the same time, the gap can be kept particularly small and tire damage can be avoided.

In the case of the commercial vehicle, in particular if the commercial vehicle is particularly large, manual parking, in particular maneuvering, in particular with a trailer, can be particularly difficult for a driver of the commercial vehicle. This can, for example, lead to corrective maneuvers with a correspondingly high time requirement and/or to clutch wear and/or to tire wear. The method according to the invention can therefore be used to keep the time required to perform the parking maneuver particularly short. Furthermore, clutch wear and/or tire wear can be avoided or kept particularly low, whereby the service life of a clutch of the commercial vehicle and/or the service life of the tires, particularly in the case of a 3-axle assembly of a trailer, can be particularly increased by avoiding unnecessary corrective traction.

By way of example, in the case of the particularly long commercial vehicle, in particular with a trailer, the driver of the commercial vehicle must pay particular attention to the way the rear axle enters the bend during the turning maneuver, for example in order to avoid a collision. In this way, the method according to the invention can be used, for example, to ensure that the rear axle enters the bend particularly safely, in particular by avoiding a collision with the object. In the case of the particularly long commercial vehicle, the turning maneuver requires a particularly large swing, for example. In this case, the method according to the invention can be used to avoid a collision with the object particularly safely, for example at the front, in particular on the outside of the bend, caused by the particularly large swing. In particular, if the commercial vehicle has a particularly long rear overhang, the rear of the commercial vehicle can swing out particularly far during the turning maneuver, in particular if the steering angle is particularly sharp. Using the method according to the invention, a collision with the object can be avoided particularly safely, in particular when the steering angle is particularly sharp. In particular, if the commercial vehicle has the trailer, a front edge on the outside of the bend of the trailer can project particularly far beyond the tractor in the transverse direction of the vehicle during the turning maneuver, in particular when the steering angle is particularly sharp. By means of the method according to the invention, a collision of this front outer edge of the trailer with the object can be avoided particularly safely.

In summary, the method according to the invention can be used to effect assistance functions for the stop approach and/or the parking maneuver and/or the turning maneuver in order to prevent the commercial vehicle from colliding with the object.

By way of example, these assistance functions can be implemented without the installation of additional components, such as a steering gear equipped with an electric motor. This means that an active steering gear can be dispensed with, for example. This means, for example, that the costs of the commercial vehicle can be kept particularly low. Furthermore, the installation space of the commercial vehicle can be designed in a particularly advantageous way, in particular it can be kept particularly small. This means, for example, that the safety of the commercial vehicle can be increased in a particularly low-effort manner. Alternatively or additionally, for example, the additional electric motor of the active steering gear can be provided for functions with a particularly high steering torque requirement, wherein the additional electric motor can be particularly small in size. The particularly small electric motor can provide advantages in terms of costs and/or weight and/or installation space of the commercial vehicle. Furthermore, requirements with regard to the functional safety of the commercial vehicle can be fulfilled particularly safely. In addition, for example, the development effort of the commercial vehicle can be kept particularly low.

Further advantages, features and details of the invention emerge from the following description of preferred exemplary embodiments and from the drawings. The features and combinations of features mentioned above in the description as well as the features and combinations of features mentioned below in the description of the figures and/or shown in the figures alone can be used not only in the combination indicated in each case, but also in other combinations or on their own, without departing from the scope of the invention.

### BRIEF DESCRIPTION OF THE DRAWING FIGURES

Here are shown:

FIG. 1 a schematic partial view of a commercial vehicle which is designed to carry out a method according to the invention;

FIG. 2 a schematic top view of a commercial vehicle, which is designed to carry out a method according to the invention, to illustrate a stop approach;

FIG. 3 a schematic top view of a commercial vehicle, which is designed to carry out a method according to the invention, to illustrate a parking maneuver;

FIG. 4 a schematic top view of a commercial vehicle, which is designed to carry out a method according to the invention, to illustrate a turning maneuver;

FIG. 5 a schematic top view of a commercial vehicle, which is designed to carry out a method according to the invention, to illustrate a turning maneuver;

FIG. 6 a schematic top view of a commercial vehicle, which is designed to carry out a method according to the invention, to illustrate a turning maneuver;

FIG. 7 a schematic top view of a commercial vehicle, which is designed to carry out a method according to the invention, to illustrate a turning maneuver;

In the figures, identical or functionally identical elements are provided with the same reference numerals.

### DETAILED DESCRIPTION

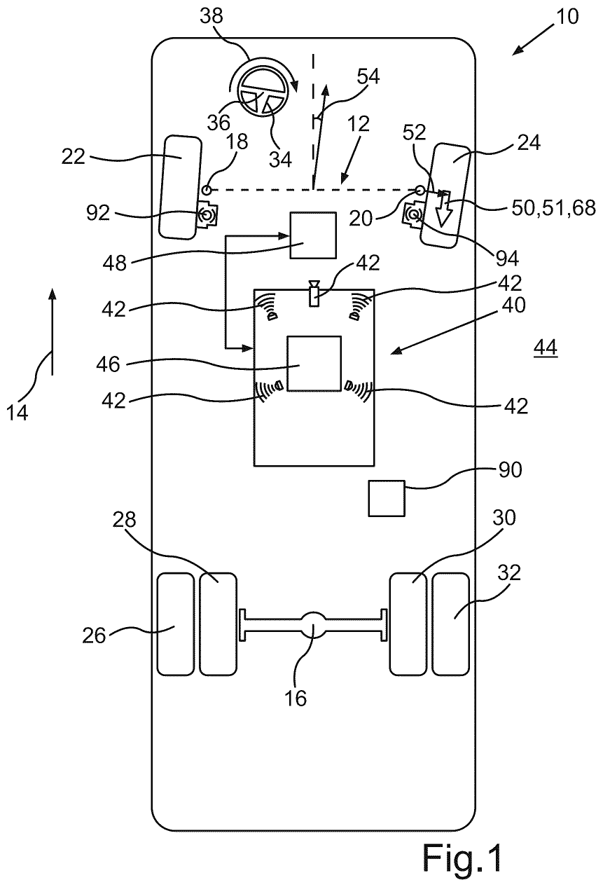

FIG. 1 shows a schematic partial sectional view of a commercial vehicle 10, which is designed, for example, as a bus, in particular as an omnibus, or as a lorry, in particular as a tractor unit. The commercial vehicle 10 has a front axle 12 and a rear axle 16 spaced apart from the front axle 12 in the longitudinal direction of the vehicle 14.

Two vehicle wheels 22, 24 are arranged on the front axle 12 which can be pivoted about a respective pivot axis 18, 20, in particular relative to a chassis or a body of the commercial vehicle 10. This means that a first of the vehicle wheels 22 is pivotable about a first of the pivot axes 18 and the second of the vehicle wheels 24 is pivotable about the second of the pivot axes 20. The vehicle wheels 22, 24 are thus designed as front wheels of the commercial vehicle 10. The vehicle wheels 22, 24 are each pivotable about a respective wheel pivot axis, in particular relative to the chassis or the body. In the exemplary embodiment shown in FIG. 1, further vehicle wheels 26, 28, 30, 32, which are different from the vehicle wheels 22, 24, are arranged on the rear axle 16 and can be described in particular as rear wheels.

The commercial vehicle 10 has a steering handle 34 provided for, in particular manually, effecting cornering or changes of direction of the commercial vehicle 10. In the exemplary embodiment shown in FIG. 1, the steering handle 34 is designed as a steering wheel which can be rotated, in particular by a driver of the commercial vehicle 10, about an axis of rotation 36, in particular relative to the chassis or the body of the commercial vehicle 10. The rotation of the steering handle 34 is illustrated in FIG. 1 by means of an arrow 38. The steering handle 34 is preferably coupled to the vehicle wheels 22, 24, in particular mechanically, in such a way that the pivoting of the vehicle wheels 22, 24 about the respective pivot axis 18, 20 can be effected by rotating the steering handle 34, in particular manually. As a result, the respective wheel 22, 24 can, for example, be pivoted about the respective pivot axis 18, 20 from a respective first position into a respective second position differing from the respective first position. As a result, a respective steering angle of the respective vehicle wheel 22, 24 can be effected, which can be described in particular as a wheel angle.

The commercial vehicle 10 has at least one driver assistance system 40. The commercial vehicle 10 is designed to carry out a method for operating the driver assistance system 40.

The commercial vehicle 10 or the driver assistance system 40 has at least one detection device 42, by means of which an environment 44 of the commercial vehicle 10 can be detected or is detected. By way of example, the commercial vehicle 10 or the driver assistance system 40 has at least one electronic computing device 46. By way of example, the detection device 42 is used to detect at least one variable characterizing the environment 44, which is transmitted from the detection device 42 to the electronic computing device 46. By way of example, the environment 44 of the commercial vehicle 10 is monitored by means of the electronic computing device 46 depending on the variable characterizing the environment 44 of the commercial vehicle 10 transmitted to the electronic computing device 46. In the exemplary embodiment shown in FIG. 1, several detection devices 42 designed to detect the environment 44 are provided. By way of example, one of the detection devices 42 is designed as an optical detection device 42, in particular as a camera. By way of example, one of the detection devices 42 is designed as a radar sensor, in particular as a long-range radar sensor.

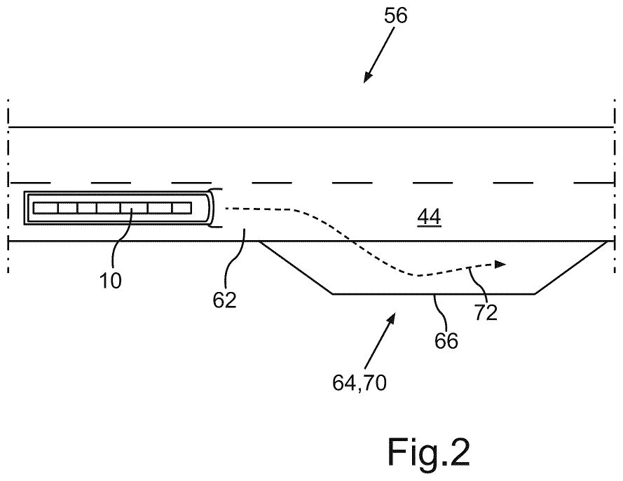

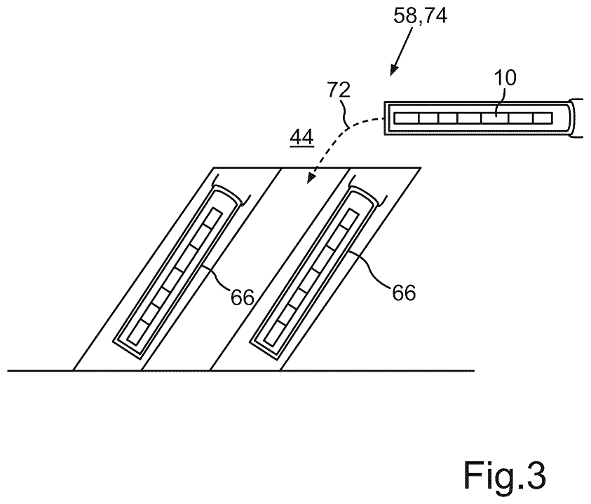

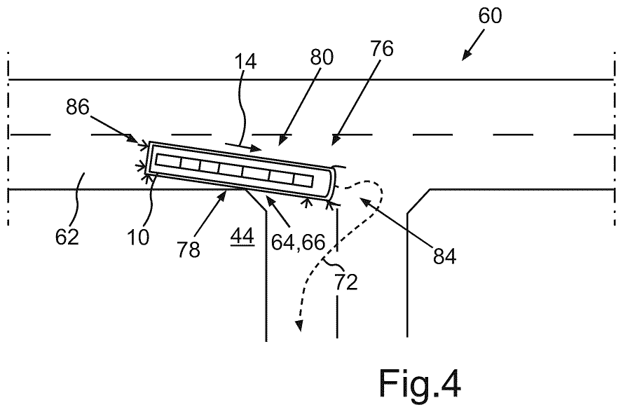

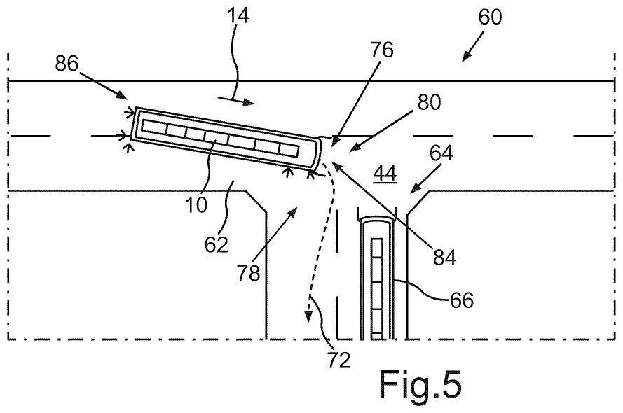

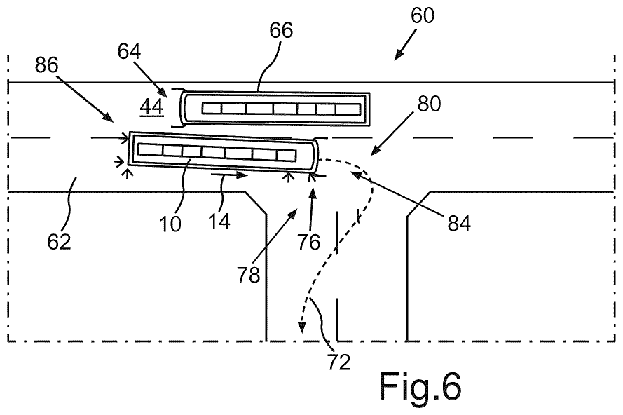

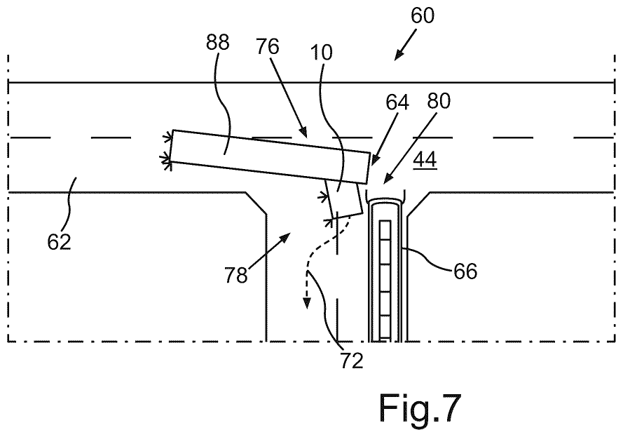

FIG. 2 shows the commercial vehicle 10 in a schematic top view to illustrate a stop approach 56. FIG. 3 shows the commercial vehicle 10 in a schematic top view to illustrate a parking maneuver 58. FIG. 4, FIG. 5, FIG. 6 and FIG. 7 each show the commercial vehicle 10 in a respective schematic top view to illustrate a respective turning maneuver 60. Furthermore, FIG. 2 and FIGS. 4 to 7 each show a road 62 on which the commercial vehicle 10 is located.

In order to be able to increase the safety of the commercial vehicle 10 in a particularly low-effort manner, it is provided that when an imminent collision 64 with an object 66 that is separate from the commercial vehicle 10 and located in the environment 44 is detected by means of the detection device 42, in particular by means of the electronic computing device 46, during the stop approach 56, the parking maneuver 58 or the turning maneuver 60 of the commercial vehicle 10, one of the vehicle wheels 22, 24 is braked, in particular in a targeted manner, by a braking intervention 50 effected by a braking device 48 of the commercial vehicle 10, whereby the vehicle wheels 22, 24 are pivoted as a result of the braking intervention 50 to prevent the collision 64 of the commercial vehicle 10 with the object 66. This means that a braking force 51, in particular a one-sided braking force, is applied to one of the vehicle wheels 22, 24 by means of the braking device 48, which, in conjunction with a lever arm 52 assigned to the respective wheel 22, 24, causes the vehicle wheels 22, 24 to pivot, in particular about the respective pivot axis 18, 22.

In the exemplary embodiment shown in FIG. 1, the second vehicle wheel 24 is braked by the braking intervention 50. The vehicle wheels 22, 24 are preferably coupled to each other, in particular mechanically, in such a way that the pivoting of one vehicle wheel 24, for example the second vehicle wheel 24, caused by the braking intervention 50, causes the pivoting of the other vehicle wheel 22, for example the first vehicle wheel 22. In other words, the braking force 51 and the lever arm 52 can cause a torque at the front axle 12, in particular referred to as steering torque, which causes the pivoting of the vehicle wheels 22, 24. By pivoting the vehicle wheels 22, 24, a resulting front axle steering angle 54 can be effected, by means of which a change of the direction of travel of the commercial vehicle 10, in particular referred to as a change in direction or change in direction of travel, can be effected. The change in direction can be understood in particular as a directional adjustment.

The imminent collision 64 of the commercial vehicle 10 with the object 66 can be avoided by changing direction. Thus, in the method, at least one lane-correcting function can be implemented by setting a steering angle with the aid of at least one individual wheel braking intervention, in particular several individual wheel braking interventions, on the front axle 12. This means that the direction of travel of the commercial vehicle 10 can be controlled by means of the driver assistance system 40 or by means of the braking device 48. This can particularly increase the safety of the commercial vehicle 10. By way of example, an accident involving the commercial vehicle 10 can be avoided. Furthermore, an electric motor provided for pivoting the vehicle wheels 22, 24, for example, can be dispensed with, whereby the effort and costs of the commercial vehicle 10 can be kept particularly low.

The lever arm 52 can be understood in particular as a kingpin offset of the front axle 12. In particular, the kingpin offset can be referred to as the scrub radius. The respective steering angle can be influenced, in particular actively, by the braking intervention 50 depending on the function of the driver assistance system 40. The braking force 51 can be understood, in particular, as a force acting between the respective vehicle wheel 22, 24 and the road 62 as a result of the braking intervention 50.

By way of example, the imminent collision 64 can be determined by means of the electronic computing device 46. This means that, for example, at least one variable characterizing the imminent collision 64 can be determined by means of the detection device 42, which can be transmitted to the electronic computing device 46, wherein the imminent collision 64 with the object 66 can be determined, in particular calculated, by means of the electronic computing device 46 depending on the transmitted variable.

By way of example, it is provided that the vehicle wheels 22, 24 are coupled, in particular mechanically, to the steering handle 34, which is rotatable about the axis of rotation 36 and is provided for manually effecting cornering or changes of direction of the commercial vehicle 10, in such a way that the steering handle 34 is rotated about the axis of rotation 36 by the pivoting of one vehicle wheel 22, 24, for example the second vehicle wheel 24, effected as a result of the braking intervention 50. This means that the pivoting of the vehicle wheels 22, 24 can be effected by the, in particular manual, rotating of the steering handle 34 and the rotating of the steering handle 34 can be effected by the pivoting of the vehicle wheels 22, 24. The braking intervention 50 can thus cause the vehicle wheels 22, 24 to pivot and the steering handle 34 to rotate. The driver can thus be given intuitive feedback. This can particularly increase the safety of the commercial vehicle 10.

It is preferably provided that when the imminent collision 64 with the object 66 is detected by means of the detection device 42, a driver of the commercial vehicle 10 is haptically warned via the steering handle 34 coupled to the vehicle wheels 22, 24 by braking with a second braking intervention 68 effected by the braking device 48 of the commercial vehicle 10. As a result, for example, the steering handle 34 coupled to the vehicle wheels 22, 24 is rotated about the axis of rotation 36 of the steering handle 34 to effect the haptic warning. As a result, the driver can be warned particularly safely, whereby the driver can, for example, steer the commercial vehicle 10 manually, in particular actively, by means of the steering handle 34, for example in order to avoid the imminent collision 64 with the object 66. This can particularly increase the safety of the commercial vehicle 10. By way of example, the haptic warning causes the driver to become attentive or particularly attentive again and can avoid the collision 64 with the object 66 himself/herself, such that active intervention by means of the driver assistance system 40 is not necessary at all, for example. In particular, the steering handle 34 can be used to provide an intuitively correct haptic warning, preferably without additional electronics.

The haptic warning can be understood to mean, for example, a steering impulse, in particular a short one, i.e., a twitching of the steering handle 34, for example. This steering impulse is preferably triggered by the second braking intervention 68. This steering impulse does not necessarily cause the steering handle 34 to turn.

The haptic warning means, for example, that other warning devices such as seat vibration motors in a vehicle seat can be omitted. This means, for example, that costs, in particular manufacturing costs and/or development costs, and/or the weight and/or installation space of the commercial vehicle 10 can be kept particularly low.

The second braking intervention 68 can, for example, be carried out before the braking intervention 50 and/or after the braking intervention 50 and/or during the braking intervention 50, i.e., overlapping the braking intervention 50, for example.

Furthermore, a direct effect on a steering of the commercial vehicle 10, in particular on the rotating of the steering handle 34, caused by the braking intervention 50 cannot be impaired by a servo-assist function of the steering, in particular due to the fact that a force introduction into the steering, in particular into the steering handle 34, comes from below from the respective vehicle wheel 22, 24.

Furthermore, the effect on the steering, in particular the rotating of the steering handle 34, can be limited in its intensity in such a way that the driver can easily override the rotating of the steering handle 34 and thus the change in direction, in particular if the change in direction is undesirable for the driver. In other words, the change in direction can preferably be overridden by the driver, in particular by manual forces applied by the driver to the steering handle 34.

It is preferably provided that the servo assistance function of the steering is provided when the steering is overridden. This is the case, for example, because the force is applied via the steering handle 34. This means that the method or the driver assistance system 40 can, for example, be integrated into a steering servo assistance system, in particular a standard one, with particularly little effort, in order to leave wheel-side steering interventions unaffected by the servo assistance on the one hand and to reinforce steering interventions effected by the driver, in particular as usual, by the servo assistance function on the other hand, whereby the wheel-side steering interventions can be overridden particularly easily by the driver. This means that steering effects can be represented particularly effectively for the assistance function, in particular without additional electro-actuator intervention options.

The object 66 is, for example, another vehicle, in particular a motor vehicle, which is separate from the commercial vehicle 10, i.e., different from the commercial vehicle 10. Alternatively, the object 66 can be, for example, a person or a curb 70.

As shown in FIG. 2, in a further embodiment of the invention, it is provided that a steering assistance for an approach to the curb 70 is effected by the braking intervention 50 during the stop approach 56. This means that the driver assistance system 40 comprises, for example, the steering assistance for the stop approach 56 to the curb 70 of a stop. In other words, the commercial vehicle 10 is specifically steered by the braking intervention 50 into a predetermined position, in particular a stopping position, which is located, for example, at the stop. The braking intervention 50 can therefore be used to steer the vehicle during the stop approach 56. As a result, collision avoidance with the curb 70 can be implemented. Furthermore, the stop can be approached particularly safely by the commercial vehicle 10, which is formed in particular as a bus. Furthermore, the comfort of the commercial vehicle 10 can be particularly increased, since, for example, the curb 70 can be approached with particularly little effort, in particular particularly precisely and/or particularly safely.

Thus, for example, the imminent collision 64 with the curb 70 can be detected as the object 66 by means of the detection device 42. A trajectory 72 of the commercial vehicle 10 is shown in FIG. 2, wherein the trajectory 72 is specifically adapted or influenced as a result of the braking intervention 50 in order to avoid the collision 64 with the object 66 or to approach the curb 70 or the stop in a targeted manner. In particular, the trajectory can be understood as a path curve.

As shown in FIG. 3, it is provided in a further embodiment that the commercial vehicle 10 performs at least one shunting maneuver 74 during the parking maneuver 58. The shunting maneuver 74 comprises, for example, at least one reverse movement, in particular a reverse cornering movement, of the commercial vehicle 10. The driver assistance system 40 can thus comprise, for example, a maneuvering function. The shunting maneuver 74 can in particular be referred to as a maneuvering process.

The braking intervention 50 can cause the commercial vehicle 10 to be steered during the parking maneuver 58, in particular during the shunting maneuver 74. The driver can be in the commercial vehicle 10, in particular at the wheel, or the driver can not be in the commercial vehicle 10, i.e., the commercial vehicle 10 can, for example, perform the parking maneuver 58, in particular the shunting maneuver 74, by remote control.

In the exemplary embodiment shown in FIG. 3, the collision 64 with a respective other vehicle as the respective object 66 can be avoided by the braking intervention 50 during the parking maneuver 58, in particular during the shunting maneuver 74. Although a yaw moment acting on the commercial vehicle 10 caused by the braking intervention 50 can act in opposition to the steering effect caused by the pivoting of the vehicle wheels 22, 24, the steering caused by the braking intervention 50 can nevertheless be particularly strong during the maneuvering function. This allows, for example, a particularly small turning circle of the commercial vehicle 10 to be implemented. The rotating of the steering handle 34 caused by the braking intervention 50 can provide the driver with target value information for carrying out the shunting maneuver 74, particularly during the shunting maneuver 74.

The commercial vehicle 10 preferably performs cornering 76 during the turning maneuver 60. As shown in FIG. 4, the imminent collision 64 with the object 66, for example the curb 70, is detected during the turning maneuver 60, in particular during cornering 76, by means of the detection device 42, for example, wherein the object 66 is arranged on a side 78 of the commercial vehicle 10 on the inside of the bend in relation to the trajectory 72 of the commercial vehicle 10 during cornering 76. As a result, the collision 64 with the object 66 located on the side 78 on the inside of the bend can be avoided particularly safely.

As shown in FIG. 5, the imminent collision 64 with the object 66, for example with the other vehicle, can alternatively or additionally be detected by means of the detection device 42, wherein the object 66 is arranged on a side 80 of the commercial vehicle 10 on the outside of the bend in relation to the trajectory 72 of the commercial vehicle 10 during cornering 76. As a result, the collision 64 of the commercial vehicle 10 with the object 66 located on the side 80 on the outside of the bend can be avoided particularly safely.

In this way, the driver assistance system 40 can be used, for example, to provide turning assistance to avoid collisions in relation to cornering 76 on the inside and/or outside of the bend particularly safely. The side 78 on the inside of the bend and the side 80 on the outside of the bend are preferably opposite sides in relation to the trajectory 72 or to cornering 76.

In a further embodiment, it is provided that the imminent collision 64 of a front and/or rear region 84, 86 of the commercial vehicle 10, with respect to the longitudinal direction 14 of the commercial vehicle 10, with the object 66 is detected by means of the detection device 42, in particular during the turning maneuver 60 or cornering 76. This is illustrated by way of example in FIG. 5, wherein in FIG. 5 the imminent collision 64 of the front region 84 of the commercial vehicle with the object 66, in particular the other vehicle, is detected by means of the detection device 42. Thus, in FIG. 5, the collision 64 at the front on the outside of the bend can be avoided in particular. In FIG. 6, it is illustrated by way of example that the imminent collision 64 of the rear region 86 of the commercial vehicle 10 with the object 66, for example with the other vehicle, is detected by the detection device 42. Thus, in FIG. 6, for example, the collision 64 at the rear on the outside of the bend can be avoided.

In a further embodiment, the imminent collision 64 of a trailer 88 of the commercial vehicle 10 with the object 66, for example the other vehicle, is detected by means of the detection device 42. This is illustrated by way of example in FIG. 7, wherein in FIG. 7 the collision 64 is detected or avoided on the side 80 of the commercial vehicle 10 on the outside of the bend in a front region of the trailer 88. As a result, the collision of the trailer 88 with the object 66 can be avoided particularly safely.

In particular, steering assistance, and in particular the haptic warning, can be effected during the turning maneuver to avoid a collision. This can, for example, cause a deceleration effect, which gives the driver additional reaction time, in particular for collision avoidance.

In summary, the collision 64 with the object 66 can be avoided particularly safely during the turning maneuver 60, for example as a result of the commercial vehicle 10 swinging out, in particular both for the commercial vehicle 10 designed as a bus and for the commercial vehicle 10 having the trailer 88.

In a further embodiment, a second detection device 90, which is in particular formed separately from the detection device 42, is used to detect a driving speed, in particular a current driving speed, of the commercial vehicle 10. Preferably, the braking intervention 50 effected by the braking device 48 is carried out depending on the detected driving speed. By way of example, the braking intervention 50 effected by the braking device 48 is carried out if the driving speed detected by the second detection device 90 is lower than a predetermined, in particular predefined, threshold value for the driving speed. Thus, for example, the braking intervention 50 or a lane correction of the commercial vehicle 10 can be carried out at a particularly low driving speed. In this way, for example, the steering angle of the commercial vehicle 10 can be corrected by means of individual wheel braking interventions on the front axle at particularly low driving speeds.

By way of example, the braking intervention 50 effected by the braking device 48 is omitted if the driving speed detected by the second detection device 90 is greater than the predetermined threshold value of the driving speed.

By way of example, a respective braking element 92, 94 is assigned to the respective vehicle wheel 22, 24 by means of which the respective vehicle wheel 22, 24 can be acted upon for braking, in particular mechanically.

By way of example, it is provided that the braking force 51 provided to effect the braking intervention 50 is effected pneumatically and/or electrically and/or hydraulically, in particular at least partially, by means of the braking device 48. The braking device 48 can thus be designed, for example, as a pneumatic braking system. Alternatively, for example, an electric and/or a hydraulic braking system can be provided.

Reference numeral list

| | |
|---|---|
| 10 | commercial vehicle |
| 12 | front axle |
| 14 | longitudinal direction of the vehicle |
| 16 | rear axle |
| 18 | first pivot axis |
| 20 | second pivot axis |
| 22 | first vehicle wheel |
| 24 | second vehicle wheel |
| 26 | further vehicle wheel |
| 28 | further vehicle wheel |
| 30 | further vehicle wheel |
| 32 | further vehicle wheel |
| 34 | steering handle |
| 36 | axis of rotation |
| 38 | arrow |
| 40 | driver assistance system |
| 42 | detection device |
| 44 | environment |
| 46 | electronic computing device |
| 48 | braking device |
| 50 | braking intervention |
| 51 | braking force |
| 52 | lever arm |
| 54 | front axle steering angle |
| 56 | top approach |
| 58 | parking maneuver |
| 60 | turning maneuver |
| 62 | road |
| 64 | collision |
| 66 | object |
| 68 | second braking intervention |
| 70 | curb |
| 72 | trajectory |
| 74 | shunting maneuver |
| 76 | cornering |
| 78 | side on the inside of the bend |
| 80 | side on the outside of the bend |
| 84 | front region |
| 86 | rear region |
| 88 | trailer |
| 90 | second detection device |
| 92 | braking element |
| 94 | braking element |

1-8. (canceled)

9. A method for operating a driver assistance system of a commercial vehicle having two vehicle wheels pivotably arranged on a front axle, the method comprising:
detecting, by at least one detection device of the driver assistance system, an environment of the commercial vehicle;
detecting, by the detection device during a stop approach, a parking maneuver, or a turning maneuver of the commercial vehicle, an imminent collision of the commercial vehicle with an object, wherein the object is separate from the commercial vehicle and is located in the environment; and
braking, by a braking device of the commercial vehicle responsive to the detection of the imminent collision, one of the two vehicle wheels to pivot the two vehicle wheels as a result of the braking to prevent the imminent collision of the commercial vehicle with the object.

10. The method of claim 9, wherein when the imminent collision with the object is detected by the detection device, a driver of the commercial vehicle is haptically warned via a steering handle coupled to the two vehicle wheels by braking by a second braking intervention effected by the braking device of the commercial vehicle.

11. The method of claim 9, wherein during the stop approach, the braking causes steering assistance for an approach to a curb.

12. The method of claim 9, wherein the commercial vehicle performs at least one shunting maneuver during the parking maneuver.

13. The method of claim 9, wherein the commercial vehicle performs cornering during the turning maneuver and the imminent collision with the object is detected by the detection device, wherein the object is arranged on a side on an inside of a bend or on a side on an outside of the bend of the commercial vehicle in relation to a trajectory of the commercial vehicle during cornering.

14. The method of claim 9, wherein the imminent collision is with a front or rear region of the commercial vehicle, with respect to a longitudinal direction of the commercial vehicle.

15. The method of claim 9, wherein the imminent collision is of a trailer of the commercial vehicle with the object.

16. The method of claim 9, further comprising:
detecting, by a second detection device of the commercial vehicle, a driving speed of the commercial vehicle, wherein the braking is effected by the braking device depending on the detected driving speed.
